(19) United States
(12) Patent Application Publication
(10) Pub. No.: US 2023/0296277 A1
(43) Pub. Date: Sep. 21, 2023

(54) HVAC SYSTEM WITH IMPROVED OPERATION OF A VARIABLE SPEED COMPRESSOR DURING A PEAK DEMAND RESPONSE

(71) Applicant: Lennox Industries Inc., Richardson, TX (US)

(72) Inventors: Rohini Brahme, Irving, TX (US); Pete Hrejsa, Carrollton, TX (US)

(21) Appl. No.: 17/655,685

(22) Filed: Mar. 21, 2022

(51) Int. Cl. F24F 11/63; G05B 19/042

(52) U.S. Cl. CPC F24F 11/63; G05B 19/042; G05B 2219/2614

(57) ABSTRACT

An HVAC system includes a variable speed compressor. A controller determines that the HVAC system is requested to operate according to a demand response during a demand response time. A curtailment compressor speed is determined that achieves the reduced power consumption requested by the demand response. At a start of the demand response time, the controller begins operating the variable speed compressor at the curtailment speed. During the demand response time, the controller adjusts the speed of the variable speed compressor using dynamic control logic with an offset setpoint temperature used as the control setpoint value when an indoor air temperature of the space is less than the offset setpoint temperature and greater than the baseline setpoint temperature.

### TECHNICAL FIELD

This disclosure relates generally to heating, ventilation, and air conditioning (HVAC) systems. More particularly, in certain embodiments, this disclosure relates to an HVAC system with improved operation of a variable speed compressor during a peak demand response.

### BACKGROUND

Heating, ventilation, and air conditioning (HVAC) systems are used to regulate environmental conditions within an enclosed space. Air is cooled via heat transfer with refrigerant flowing through the HVAC system and returned to the enclosed space as conditioned air.

### SUMMARY OF THE DISCLOSURE

In some cases, HVAC systems may be required to operate under restricted operating requirements to reduce power consumption during times of peak electricity demand and/or decreased electricity supply, referred to in this disclosure as peak demand response times or demand response times. For example, a third party such as a utility provider may enforce certain operating restrictions upon HVAC systems during peak demand response times. A peak demand response time may correspond, for example, to a time period associated with high outdoor temperatures or any other time when electrical power consumption is expected (e.g., based on a forecast or projection) to be increased. Generally, the third party (e.g., a utility provider) provides a request, referred to herein as a demand response, which specifies an upper limit on power consumption by an HVAC system during a peak demand response time.

This disclosure solves problems of previous HVAC systems by facilitating improved comfort during peak demand response times using a dynamic control strategy that helps improve occupant comfort during a demand response time, while still satisfying the energy-saving requirements of the demand response. For example, rather than shutting off a variable speed compressor at the start of a demand response time, as is conventionally performed for demand response operation, the compressor is instead operated in a more efficient mode at a curtailment speed that is determined to satisfy the energy-saving requirements of the demand response. In this way, it takes longer for the space to warm than if a conventional demand response operation strategy were used. If the temperature exceeds an offset setpoint temperature (e.g., an increased setpoint temperature used during the demand response time to decrease energy consumption), control logic used to set the speed of the variable speed compressor may be adjusted such that increased cooling can be provided to cool the space back to a comfortable temperature range. In certain embodiments, the systems and methods described in this disclosure may be integrated into a practical application of an HVAC controller that improves system performance and occupant comfort during peak demand response times by more effectively and efficiently operating a variable speed compressor as summarized briefly above and described throughout this disclosure.

Certain embodiments may include none, some, or all of the above technical advantages. One or more other technical advantages may be readily apparent to one skilled in the art from the figures, descriptions, and claims included herein.

In an embodiment, an HVAC system is configured to regulate a temperature of a space. The HVAC system includes a variable speed compressor configured to operate at a plurality of speeds and compress a refrigerant used to cool air provided to the space and a controller communicatively coupled to the variable speed compressor. The controller has a memory that stores control logic that includes an integral gain and a control setpoint value and a processor coupled to the memory. The controller determines that the HVAC system is requested to operate according to a demand response during a demand response time. The demand response is a request to operate the HVAC system at a reduced power consumption. The demand response is associated with an offset setpoint temperature that is greater than a baseline setpoint temperature used during normal operation of the HVAC system outside of the demand response time. A curtailment compressor speed is determined that achieves the reduced power consumption requested by the demand response. At a start of the demand response time, the controller begins operating the variable speed compressor at the curtailment speed. During the demand response time, the controller adjusts the speed of the variable speed compressor using the control logic with the offset setpoint temperature used as the control setpoint value when an indoor air temperature of the space is less than the offset setpoint temperature and greater than the baseline setpoint temperature.

### BRIEF DESCRIPTION OF THE DRAWINGS

For a more complete understanding of the present disclosure, reference is now made to the following description, taken in conjunction with the accompanying drawings, in which:

FIG. 1 is a diagram of an example HVAC system configured for improved operation during peak demand response times;

FIG. 2 is a plot illustrating an example indoor air temperature that may be achieved over time using the system of FIG. 1; and

FIG. 3 is a flowchart of an example method of operating the system of FIG. 1.

### DETAILED DESCRIPTION

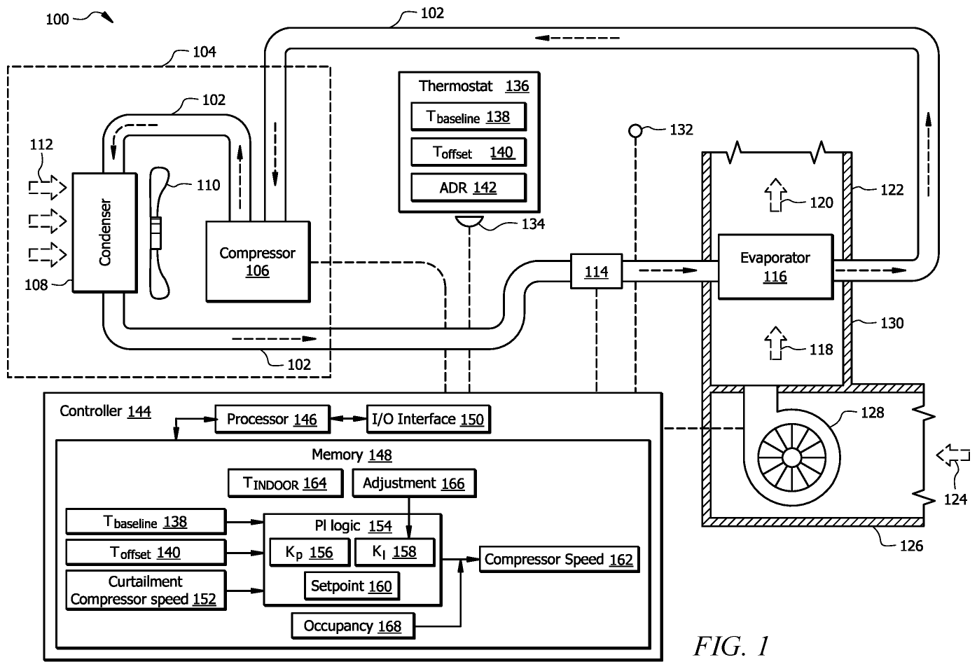

Embodiments of the present disclosure and its advantages are best understood by referring to FIGS. 1 through 3 of the drawings, like numerals being used for like and corresponding parts of the various drawings.

As described above, prior to the present disclosure, there was a lack of tools for improving comfort in a conditioned space in response to a demand response (i.e., a request for decreased HVAC energy consumption). This disclosure recognizes that temperature in a space (e.g., a home, office, or other building) that is serviced by an HVAC system with a variable speed compressor can be maintained at more comfortable levels than was previously possible by using dynamic control logic that allows cooling to be provided at lower, more energy-efficient compressor speeds during the demand response time. In this way, the space serviced by the HVAC system is maintained at a more comfortable temperature for a longer portion of the demand response time than was previously possible using conventional control strategies.

### HVAC System

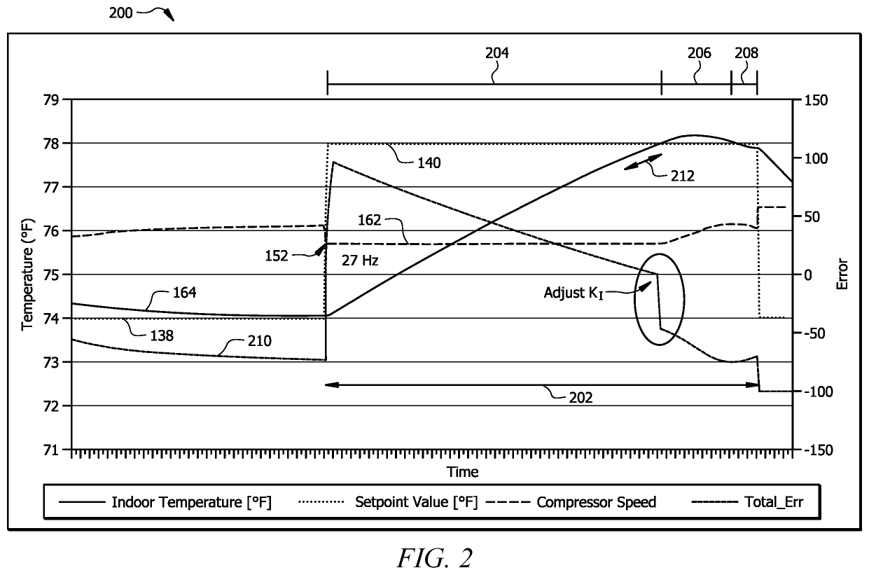

FIG. 1 shows an example HVAC system 100 configured to operate a variable speed compressor 106 using dynamic control logic 154 in order to improve occupant comfort during demand response times. A demand response 142 generally indicates an upper limit on power consumption by the HVAC system 100 during a future period of time (e.g., demand response time 202 of FIG. 2). When a demand response 142 is received, a controller 144 of the HVAC system 100 determines a curtailment speed 152 at which to initially operate the variable speed compressor 106 in order to continue providing cooling while meeting the energy-savings requirements of the demand response 142. The variable speed compressor 106 is then operated using an offset setpoint temperature 140, which may be indicated by the demand response 142. The offset setpoint temperature 140 is generally a higher temperature value than would normally be requested during cooling mode operation and is intended to reduce energy consumption by the HVAC system 100.

The HVAC system 100 conditions air for delivery to a conditioned space (e.g., all or a portion of a room, a house, an office building, a warehouse, or the like). In some embodiments, the HVAC system 100 is a rooftop unit (RTU) that is positioned on the roof of a building, and the conditioned air is delivered to the interior of the building. In other embodiments, portion(s) of the system 100 may be located within the building and portion(s) outside the building. The HVAC system 100 may include one or more heating elements, not shown for convenience and clarity. The HVAC system 100 may be configured as shown in FIG. 1 or in any other suitable configuration. For example, the HVAC system 100 may include additional components or may omit one or more components shown in FIG. 1.

The HVAC system 100 includes a working-fluid conduit subsystem 102, at least one condensing unit 104, an expansion valve 114, an evaporator 116, a blower 128, one or more thermostats 136, and a controller 144. The working-fluid conduit subsystem 102 facilitates the movement of a working fluid (e.g., a refrigerant) through a cooling cycle such that the working fluid flows as illustrated by the dashed arrows in FIG. 1. The working fluid may be any acceptable working fluid including, but not limited to hydroflurocarbons (e.g. R-410A) or any other suitable type of refrigerant.

The condensing unit 104 includes a compressor 106, a condenser 108, and a fan 110. In some embodiments, the condensing unit 104 is an outdoor unit while other components of system 100 may be located indoors. In typical embodiments, the compressor 106 is a variable speed compressor that can be operated at a range of speeds. The compressor 106 is coupled to the working-fluid conduit subsystem 102 and compresses (i.e., increases the pressure of) the working fluid. The compressor 106 is in signal communication with the controller 144 using wired and/or wireless connection. The controller 144 provides commands and/or signals to control operation of the compressor 106 and/or receive signals from the compressor 106 corresponding to a status of the compressor 106. For example, the controller 144 may provide signals to instruct the compressor 106 to operate at a determined compressor speed 162. The control logic 154 used to determine the compressor speed 162 is described in greater detail below.

The condenser 108 is configured to facilitate movement of the working fluid through the working-fluid conduit subsystem 102. The condenser 108 is generally located downstream of the compressor 106 and is configured to remove heat from the working fluid. The fan 110 is configured to move air 112 across the condenser 108. For example, the fan 110 may be configured to blow outside air through the condenser 108 to help cool the working fluid flowing therethrough. The fan 110 may be in communication with the controller 144 (e.g., via wired and/or wireless communication) to receive control signals for turning the fan 110 on and off and/or adjusting a speed of the fan 110. The compressed, cooled working fluid flows from the condenser 108 toward the expansion valve 114.

The expansion valve 114 is coupled to the working-fluid conduit subsystem 102 downstream of the condenser 108 and is configured to remove pressure from the working fluid. In this way, the working fluid is delivered to the evaporator 116. In general, the expansion valve 114 may be a valve such as an expansion valve or a flow control valve (e.g., a thermostatic expansion valve (TXV)) or any other suitable valve for removing pressure from the working fluid while, optionally, providing control of the rate of flow of the working fluid. The expansion valve 114 may be in communication with the controller 144 (e.g., via wired and/or wireless communication) to receive control signals for opening and/or closing associated valves and/or to provide flow measurement signals corresponding to the rate of working fluid flow through the working-fluid conduit subsystem 102.

The evaporator 116 is generally any heat exchanger configured to provide heat transfer between air flowing through (or across) the evaporator 116 (i.e., airflow 118 contacting an outer surface of one or more coils of the evaporator 116) and working fluid passing through the interior of the evaporator 116. The evaporator 116 may include one or more circuits of coils. The evaporator 116 is fluidically connected to the compressor 106, such that working fluid generally flows from the evaporator 116 to the condensing unit 104 when the HVAC system 100 is operating to provide cooling.

A portion of the HVAC system 100 is configured to move airflow 118 provided by the blower 128 across the evaporator 116 and out of the duct sub-system 122 as conditioned airflow 120. Return air 124, which may be air returning from the building, fresh air from outside, or some combination, is pulled into a return duct 126. A suction side of the blower 128 pulls the return air 124. The blower 128 discharges airflow 118 into a duct 130 such that airflow 118 crosses the evaporator 116 or heating elements (not shown) to produce conditioned airflow 120. The blower 128 is any mechanism for providing airflow 118 through the HVAC system 100. For example, the blower 128 may be a constant speed or variable speed circulation blower or fan. Examples of a variable speed blower include, but are not limited to, belt-drive blowers controlled by inverters, direct-drive blowers with electronic commuted motors (ECM), or any other suitable type of blower.

The HVAC system 100 includes one or more sensors 132, 134 in signal communication with the controller 144 (e.g., via wired and/or wireless connection). Sensor 132 is positioned and configured to measure an indoor air temperature 164. Sensor 134 is positioned and configured to measure an occupancy 168 of the space serviced by the HVAC system 100. For example, an occupancy sensor 134 may be a motion sensor or the like. In some cases, occupancy 168 may be determined using known positions of occupants of the space. For example, geofencing may be used to determine occupancy based on the locations of mobile devices operated by occupants of the space. The HVAC system 100 may include one or more further sensors (not shown for conciseness), such as sensors for measuring air humidity and/or any other properties of a conditioned space (e.g. a room of the conditioned space). Sensors 132, 134 and/or any other sensors may be positioned anywhere within the conditioned space, the HVAC system 100, and/or the surrounding environment.

The thermostat 136 may be located within the conditioned space (e.g. a room or building) serviced by the HVAC system 100. The controller 144 may be separate from or integrated within the thermostat 136. The thermostat 136 is configured to allow a user to input a desired temperature or baseline setpoint temperature 138 for the conditioned space. The thermostat 136 may also indicate or allow input of an offset setpoint temperature 140 that is used to conserve energy in response to a demand response 142. In some cases, the demand response 142 provides the offset setpoint temperature 140. In some embodiments, the thermostat 136 includes a user interface and display for displaying information related to the operation and/or status of the HVAC system 100. For example, the user interface may display operational, diagnostic, and/or status messages and provide a visual interface that allows at least one of an installer, a user, a support entity, and a service provider to perform actions with respect to the HVAC system 100. For example, the user interface may provide for display of messages related to the status and/or operation of the HVAC system 100 (e.g., whether the HVAC system 100 is being operated for a demand response 142).

The thermostat 136 (and/or controller 144) may be in communication with a utility provider or other third party tasked with overseeing and/or regulating energy consumption by the HVAC systems 100. For example, a utility provider or third party may be a company or organization that distributes energy to homes and businesses. In situations in which energy demand is anticipated to exceed supply, a demand response 142 may be transmitted to HVAC system 100. As described above, the demand response 142 indicates a prescribed reduction in energy consumption (e.g., a percent reduction in energy consumption from a baseline or average value) or a maximum energy consumption (e.g., a maximum permitted energy consumption per time) during the future period of time during which a decrease in energy consumption is needed.

The controller 144 is communicatively coupled (e.g., via wired and/or wireless connection) to components of the HVAC system 100 and configured to control their operation. The controller 144 generally determines that a demand response 142 has been received and that a time period (e.g., demand response time 202 of FIG. 2) is upcoming during which a reduction in energy consumption by the HVAC system 100 is requested. The controller 144 then determines the curtailment speed 152 for initially operating the compressor 106 during the demand response time. The curtailment speed 152 is the speed at which the reduced power consumption requested by the demand response 142 is achieved. At the start of the demand response time indicated by the demand response 142, the compressor 106 operates at the curtailment speed 152. For example, the controller 144 may send signals at the start time of the demand response 142 causing the compressor 106 to operate at the curtailment speed 152 (e.g., such that the compressor speed 162 is the curtailment speed 152).

During the demand response time, the controller 144 uses the control logic 154 to adjust the compressor speed 162. The control logic includes a proportional gain 156 (Kₚ), an integral gain 158 (KO, and a setpoint value 160. During normal cooling operation of the HVAC system 100 (i.e., not during a demand response time), the setpoint value 160 is the baseline setpoint temperature 138. During a demand response time, the offset setpoint temperature 140 is used as setpoint value 160. However, rather than allowing the variable speed compressor 106 to turn off at the start of a demand response time, the compressor speed 162 is set to the curtailment speed 152, and the control logic 154 is then used to adjust the compressor speed 162 as needed. By not turning off the compressor 106, the space serviced by the HVAC system 100 can be maintained at a cooler and more comfortable temperature 164, while still satisfying the energy-saving requirements of the demand response 142.

The control logic 154 may be represented by the following equation:

v(t*)=K_{P}(Tₛₑₜₚₒᵢₙₜ−T_{indoor}(t*))+K_{I∫(}Tₛₑₜₚₒᵢₙₜ−T_{indoor}(t*))t*

where v(t*) is the compressor speed 162 as a function of time (t*), Kₚ is the proportional gain 156, K_{I} is the integral gain 158, Tₛₑₜₚₒᵢₙₜ is the setpoint value 160 (e.g., the offset setpoint temperature 140 during a demand response time or the baseline setpoint temperature 138 during normal cooling mode operation), and T_{indoor}(t*) is the indoor temperature 164 at a given time (t*). In general, t* is the time from the start of the demand response time (or the time from the start of accumulating the integral component of the above equation).

The indoor temperature 164 is monitored and used to adjust the compressor speed 162 based on the control logic 154. Parameters of the control logic 154 may also be adjusted based on the value of the indoor temperature 164 during the demand response time. TABLE 1 below illustrates different example configurations of the control logic 154 for operating the variable speed compressor 106 both during a demand response time (rows two through four of TABLE 1) and during normal cooling mode operation (row five of TABLE 1).

TABLE 1
Example configuration of control logic parameters
under different operating conditions

| Demand | | Initial | | | |
|---|---|---|---|---|---|
| Response? | Condition | speed | Tₛₑₜₚₒᵢₙₜ | K_{P} | K_{I} |
| Yes | T_{baseline} < | Curtailment | T_{offset} | Predefined | Predefined |
| | T_{indoor} < T_{offset} | speed | | or 0 | |
| Yes | T_{indoor} > T_{offset} | Current | T_{offset} | Predefined | Adjusted |
| | | speed | | or 0 | value |
| Yes | T_{indoor} < T_{baseline} | Current | T_{offset} | Predefined | Adjust to |
| | | speed | | | initial value |
| | | | | | of 0 |
| No | — | Current | T_{baseline} | Predefined | Predefined |
| | | speed | | | |

Under conditions where the HVAC system 100 is operating according to a demand response 142 and the indoor temperature 164 is greater than the baseline setpoint temperature 138 and less than the offset setpoint temperature 140, the compressor speed 162 is initially set to the curtailment speed 152. The proportional gain 156 and integral gain 158 are adjusted via adjustment 166 as shown in row two of TABLE 1. The proportional gain 156 may be set to a predefined value or to zero, and integral gain 158 may be adjusted by adjustment 166 to a predefined value. The gains 156, 158 are generally set to values that cause the compressor speed 162 to remain at or near the curtailment speed 152 until the indoor temperature 164 is near or exceeds the offset setpoint temperature 140.

Under conditions where the HVAC system 100 is operating according to a demand response 142 and the indoor temperature 164 is greater than the offset setpoint temperature 140, the compressor speed 162 is initially allowed to remain at its current speed 162, and the proportional gain 156 and integral gain 158 are adjusted via adjustment 166 as shown in row three of TABLE 1 to allow the compressor speed 162 to increase to provide additional cooling to the space to the extent allowed by the energy-saving requirements of the demand response 142. For example, the integral gain 158 may be increased so that the control logic 154 more rapidly increases the compressor speed 162 to cool the space. If allowed by the demand response 142, the energy-saving requirements of the demand response 142 may be temporarily ignored under these conditions to ensure the space does not become too hot. In other words, the controller 144, while operating the compressor 106 according at a given compressor speed 162, may determine that the indoor air temperature 164 becomes greater than a predefined maximum temperature (e.g., the offset setpoint temperature 140) and increase cooling to bring the indoor air temperature 164 below this level. For example, after determining that the indoor air temperature 164 is greater than the predefined maximum temperature, the controller 144 may cause the variable speed compressor 106 to operate at an increased compressor speed 162 at least until the indoor air temperature 164 becomes less than the predefined maximum temperature (e.g., the offset setpoint temperature 140). In this way, the demand response 142 may be briefly paused to ensure that the space remains adequately comfortable for occupants.

Under conditions where the HVAC system 100 is operating according to a demand response 142 and the indoor temperature 164 is less than the baseline setpoint temperature 138 (see row four of TABLE 1 above), the compressor speed 162 is initially set to its current speed, and the proportional gain 156 and integral gain 158 are adjusted as shown in row four of TABLE 1 to stop providing cooling because the space has become colder than desired.

When the HVAC system 100 is no longer operating according to a demand response 142 (see row five of TABLE 1), the compressor speed 162 is initially set to its current speed, and the setpoint value 160 used by the control logic 154 is the baseline setpoint temperature 138. The gains 156, 158 may be returned to predefined default values for normal cooling mode operation.

As illustrated in FIG. 1, in some cases, the compressor speed 162 may be adjusted based at least in part on occupancy 168 of the space cooled by the HVAC system 100. Occupancy 168 may be “occupied” if one or more people are in the space or “unoccupied” if no one is in the space. An occupancy sensor 134 may be used to determine the occupancy 168, as described above. If the space serviced by the HVAC system 100 becomes unoccupied during the demand response time, the compressor speed 162 may be adjusted to a lower value, or the compressor 106 may be shut off at least temporarily when the serviced space is unoccupied.

The controller 144 includes a processor 146, memory 148, and input/output (I/O) interface 150. The processor 146 comprises one or more processors operably coupled to the memory 148. The processor 146 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs) that communicatively couples to memory 148 and controls the operation of HVAC system 100. The processor 146 may be a programmable logic device, a microcontroller, a microprocessor, or any suitable combination of the preceding. The processor 146 is communicatively coupled to and in signal communication with the memory 148. The one or more processors are configured to process data and may be implemented in hardware or software. For example, the processor 146 may be 8-bit, 16-bit, 32-bit, 64-bit or of any other suitable architecture. The processor 146 may include an arithmetic logic unit (ALU) for performing arithmetic and logic operations, processor registers that supply operands to the ALU and store the results of ALU operations, and a control unit that fetches instructions from memory 148 and executes them by directing the coordinated operations of the ALU, registers, and other components. The processor may include other hardware and software that operates to process information, control the HVAC system 100, and perform any of the functions described herein (e.g., with respect to FIGS. 1-3). The processor 146 is not limited to a single processing device and may encompass multiple processing devices.

The memory 148 comprises one or more disks, tape drives, or solid-state drives, and may be used as an over-flow data storage device, to store programs when such programs are selected for execution, and to store instructions and data that are read during program execution. The memory 148 may be volatile or non-volatile and may comprise ROM, RAM, ternary content-addressable memory (TCAM), dynamic random-access memory (DRAM), and static random-access memory (SRAM). The memory 148 is operable to store any suitable set of instructions, logic, rules, and/or code for executing the functions described in this disclosure with respect to FIGS. 1-3. The memory 148 may store the temperature setpoints 138, 140, determined curtailment speed 152, control logic 154, occupancy 168, indoor temperatures 164, and compressor speed 162.

The I/O interface 150 is configured to communicate data and signals with other devices. For example, the I/O interface 150 may be configured to communicate electrical signals with the other components of the HVAC systems 100. The I/O interface 150 may send signals that cause the compressor 106 to operate at the compressor speed 162 determined by control logic 154. The I/O interface 150 may use any suitable type communication protocol. The I/O interface 150 may comprise ports and/or terminals for establishing signal communications between the controller 144 and other devices. The I/O interface 150 may be configured to enable wired and/or wireless communications.

Connections between various components of the HVAC system 100 and between components of system 100 may be wired or wireless. For example, conventional cable and contacts may be used to couple the thermostat 136 to the controller 144 and various components of the HVAC system 100, including, the compressor 106, the expansion valve 114, the blower 128, and/or sensor(s) 132, 134. In some embodiments, a wireless connection is employed to provide at least some of the connections between components of the HVAC system 100. In some embodiments, a data bus couples various components of the HVAC system 100 together such that data is communicated there between. In a typical embodiment, the data bus may include, for example, any combination of hardware, software embedded in a computer readable medium, or encoded logic incorporated in hardware or otherwise stored (e.g., firmware) to couple components of HVAC system 100 to each other.

As an example and not by way of limitation, the data bus may include an Accelerated Graphics Port (AGP) or other graphics bus, a Controller Area Network (CAN) bus, a front-side bus (FSB), a HYPERTRANSPORT (HT) interconnect, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. In various embodiments, the data bus may include any number, type, or configuration of data buses, where appropriate. In certain embodiments, one or more data buses (which may each include an address bus and a data bus) may couple the controller 144 to other components of the HVAC system 100.

In an example operation of the system 100, the compressor 106 of the HVAC system 100 is initially operating at a compressor speed 162 determined by the control logic 154 using the baseline setpoint temperature 138 as the setpoint value 160. A demand response 142 is then received indicating that a decrease in energy consumption is needed during an upcoming period of time. FIG. 2 shows a plot 200 of indoor temperature 164 (solid line) over time before during and after a demand response time 202 indicated by the demand response 142. The demand response 142 indicates that energy consumption by the HVAC system 100 should be decreased during demand response time 202. Prior to the demand response time 202, the control logic 154 determines the compressor speed 162 using the baseline setpoint temperature 138 as setpoint value 160 (see row five of TABLE 1 above). The compressor speed 162 is shown as the dashed line in FIG. 2. The compressor speed is 162 is adjusted up and down based on an error 210, which is a measure of the difference between the setpoint value 160 used by the control logic 154 and the indoor temperature 164 and may include proportional and/or integral components (see equation above). When there is a negative error 210, the compressor speed 162 may be increased. Otherwise, the compressor speed 162 may remain the same (e.g., at the curtailment speed 152 during time portion 204) or decrease, depending on values of the gains 156, 158.

At the start of the demand response time 202, the control logic 154 is adjusted as shown in row two of TABLE 1 above. The compressor speed 162 is adjusted to the curtailment speed 152, and the control logic 154 uses the offset setpoint temperature 140 as the setpoint value 160. During an initial portion of time 204 of the demand response time 202, the indoor temperature 164 is less than the offset setpoint temperature 140 and greater than the baseline setpoint temperature 138. During this portion of time 204, the control logic is configured as shown in row two of TABLE 1 (see above). The compressor speed 162 stays at or near the curtailment speed 152 during time portion 204 of the demand response time 202.

At the start of time portion 206 of the demand response time, the indoor temperature reaches and begins to exceed the offset setpoint temperature 140. For this time portion 206, the control logic 154 is adjusted as shown in row three of TABLE 1 to increase the compressor speed 162 by adjusting the integral gain 158. When the integral gain 158 is adjusted, the error 210 determined by the control logic 154 increases in magnitude, such that compressor speed 162 is increased more rapidly to provide a relatively rapid correction to the indoor temperature 164. The adjustment 166 to the integral gain 158 may be based at least in part on recent values of the indoor temperature 164. For example, if the indoor temperature 164 has been increasing more rapidly, a larger adjustment 166 may be made to the integral gain 158. For example, the change 212 (e.g., a slope of temperature 164 vs. time) of indoor temperature 164 over a recent time period may be used to determine the adjustment 166 to the integral gain 158.

During the brief time portion 208 before the end of the demand response time 202, the indoor temperature 164 moves below the offset setpoint temperature 140, and the control logic 154 may be adjusted accordingly (e.g., by causing the compressor speed 162 to decrease as shown in FIG. 2). When demand response time 202 is over, the control logic 154 returns to operating the compressor 106 using the baseline setpoint temperature 138 as the setpoint value 160.

### Example Method of Operation

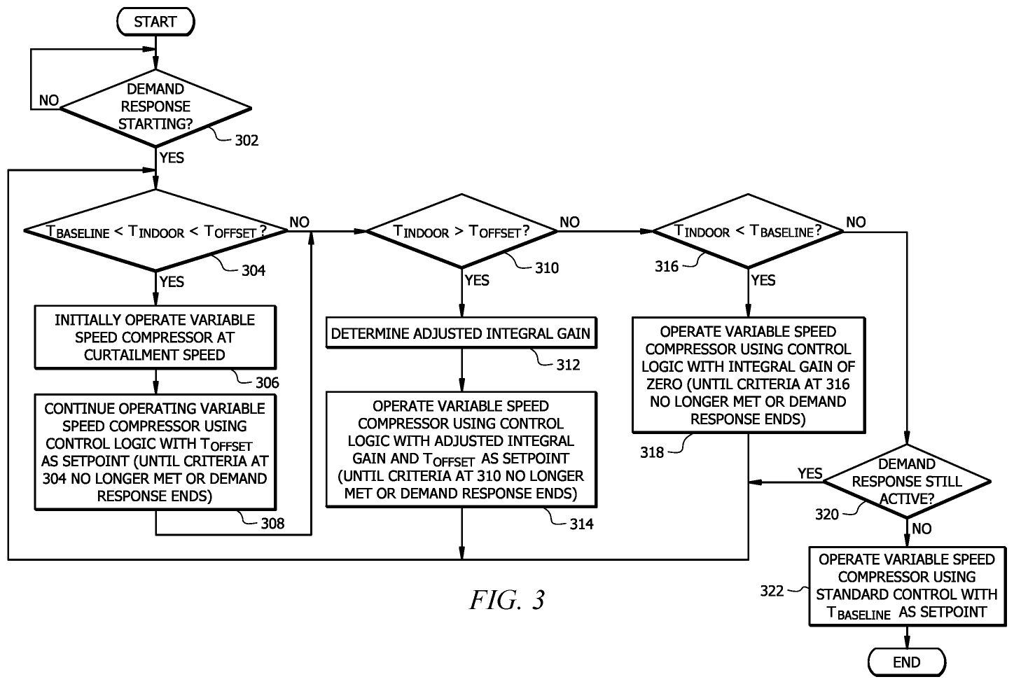

FIG. 3 is a flowchart of an example method 300 of operating the system of FIG. 1. Steps of method 300 may be implemented using the processor 146, memory 148, and I/O interface 150 of the controller 144. Method 300 may begin at step 302 where it is determined whether a demand response 142 has been received and a demand response time 202 is starting. If this is the case, the controller 144 continues to step 304. Otherwise, the controller 144 waits for a demand response time 202 to start.

At step 304, the controller 144 determines whether the indoor temperature 164 is less than the offset setpoint temperature 140 and greater than the baseline setpoint temperature 138 (see conditions for row two of TABLE 1). If the conditions of step 304 are met, the controller 144 proceeds to step 306 and initially operates the compressor 106 at the curtailment speed 152. The curtailment speed 152 is the speed at which the reduced power consumption requested by the demand response 142 is achieved. The curtailment speed 152 may be determined by determining an amount of energy consumed by the HVAC system 100 as a function of the compressor speed 162 and determining the curtailment speed 152 as the compressor speed 162 that corresponds to an energy consumption allowed during the demand response time 202. At step 308, the controller 144 operates the compressor 106 with control logic 154 configured as shown in row two of TABLE 1 with the setpoint value 160 set to the offset setpoint temperature 140.

If the conditions of step 304 are not met or are no longer met at some point during operation of the HVAC system 100 during a demand response time 202, the controller 144 determines whether the indoor temperature 164 is greater than the offset setpoint temperature 140 at step 310. If the condition at step 310 is met, the controller 144 proceeds to step 312 and determines the adjusted integral gain 158 (e.g., determines the adjustment 166 to the integral gain 158). For example, the change 212 (e.g., a slope of temperature 164 vs. time) of indoor temperature 164 over a recent time period may be used to determine the adjustment 166 to the integral gain 158, as described above with respect to FIG. 2. At step 314, the controller 144 operates the compressor 106 using the control logic 154 with the adjusted integral gain 158.

If the conditions of step 310 are not met or are no longer met at some point during operation of the HVAC system 100 during a demand response time 202, the controller 144 determines whether the indoor temperature 164 is less than the baseline setpoint temperature 138 at step 316. If the condition at step 316 is met, the controller 144 proceeds to step 318. At step 318, the controller 144 operates the variable speed compressor 106 with an integral gain 158 of zero (or shuts off the compressor 106).

At step 320, the controller 144 determines whether the demand response 142 is still active (e.g., whether the current time is within the demand response time 202). If the demand response 142 is still active, the controller 144 continues to operate the compressor using the control logic 158 as modified at steps 304-318. Otherwise, if the demand response 142 is no longer active, the controller 144 proceeds to step 322 and operates the compressor using the cooling mode control logic 154 where the setpoint value 160 is the baseline setpoint temperature 138 (see row five of TABLE 1 above).

Modifications, additions, or omissions may be made to method 300 depicted in FIG. 3. Method 300 may include more, fewer, or other steps. For example, steps may be performed in parallel or in any suitable order. While at times discussed as the controller 144 performing the steps, any suitable components (e.g., a thermostat 136 of FIG. 1) of the HVAC system 100 may perform one or more steps of the method 300.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. A heating, ventilation, and air conditioning (HVAC) system configured to regulate a temperature of a space, the HVAC system comprising:
a variable speed compressor configured to operate at a plurality of speeds and compress a refrigerant used to cool air provided to the space;
a controller communicatively coupled to the variable speed compressor, the controller comprising:
a memory configured to store control logic comprising an integral gain and a control setpoint value; and
a processor coupled to the memory and configured to:
determine that the HVAC system is requested to operate according to a demand response during a demand response time, wherein the demand response is a request to operate the HVAC system at a reduced power consumption, wherein the demand response is associated with an offset setpoint temperature that is greater than a baseline setpoint temperature used during normal operation of the HVAC system outside of the demand response time;
determine a curtailment compressor speed that achieves the reduced power consumption requested by the demand response;
at a start of the demand response time, begin operating the variable speed compressor at the curtailment speed; and
during the demand response time, adjust the speed of the variable speed compressor using the control logic with the offset setpoint temperature used as the control setpoint value when an indoor air temperature of the space is less than the offset setpoint temperature and greater than the baseline setpoint temperature.

2. The HVAC system of claim 1, wherein the controller is further configured to determine the curtailment speed by:
determining an amount of energy consumed by the HVAC system as a function of a speed of the variable speed compressor; and
determining the curtailment speed as the speed of that variable speed compressor that corresponds to an energy consumption allowed during the demand response time.

3. The HVAC system of claim 1, wherein the controller is further configured to:
determine that the indoor air temperature of the space is greater than the offset setpoint temperature; and
after determining that the indoor air temperature of the space is greater than the offset setpoint temperature, adjust the integral gain of the control logic of the controller, such that the speed of the variable speed compressor increases.

4. The HVAC system of claim 3, wherein the controller is further configured to adjust the integral gain by an amount determined based at least in part on a value of the indoor air temperature.

5. The HVAC system of claim 4, wherein the controller is further configured to determine the amount based on a change in the value of the indoor air temperature over a previous interval of time.

6. The HVAC system of claim 1, wherein the controller is further configured to:
determine that the indoor air temperature of the space is less than the baseline setpoint temperature; and
after determining that the indoor air temperature of the space is less than the baseline setpoint temperature, adjust the integral gain to zero or turn off the variable speed compressor.

7. The HVAC system of claim 1, wherein the controller is further configured to:
determine that the demand response time is ended; and
after determining that the demand response time is ended, adjust the speed of the variable speed compressor using the control logic using the baseline setpoint temperature as the control setpoint value.

8. A method of operating a heating, ventilation, and air conditioning (HVAC) system configured to regulate a temperature of a space, the method comprising:
determining that the HVAC system is requested to operate according to a demand response during a demand response time, wherein the demand response is a request to operate the HVAC system at a reduced power consumption, wherein the demand response is associated with an offset setpoint temperature that is greater than a baseline setpoint temperature used during normal operation of the HVAC system outside of the demand response time;
determining a curtailment compressor speed for a variable speed compressor of the HVAC system, wherein the curtailment compressor speed achieves the reduced power consumption requested by the demand response;
at a start of the demand response time, operating the variable speed compressor at the curtailment speed; and
during the demand response time, adjusting the speed of the variable speed compressor using the control logic with the offset setpoint temperature used as the control setpoint value when an indoor air temperature of the space is less than the offset setpoint temperature and greater than the baseline setpoint temperature.

9. The method of claim 8, further comprising determining the curtailment speed by:
determining an amount of energy consumed by the HVAC system as a function of a speed of the variable speed compressor; and
determining the curtailment speed as the speed of that variable speed compressor that corresponds to an energy consumption allowed during the demand response time.

10. The method of claim 8, further comprising:
determining that the indoor air temperature of the space is greater than the offset setpoint temperature; and
after determining that the indoor air temperature of the space is greater than the offset setpoint temperature, adjusting the integral gain of the control logic of the controller, such that the speed of the variable speed compressor increases.

11. The method of claim 10, further comprising adjusting the integral gain by an amount determined based at least in part on a value of the indoor air temperature.

12. The method of claim 11, further comprising determining the amount based on a change in the value of the indoor air temperature over a previous interval of time.

13. The method of claim 8, further comprising:
determining that the indoor air temperature of the space is less than the baseline setpoint temperature; and
after determining that the indoor air temperature of the space is less than the baseline setpoint temperature, adjusting the integral gain to zero or turn off the variable speed compressor.

14. The method of claim 8, further comprising:
determining that the demand response time is ended; and
after determining that the demand response time is ended, adjusting the speed of the variable speed compressor using the control logic using the baseline setpoint temperature as the control setpoint value.

15. A controller of a heating, ventilation, and air conditioning (HVAC) system, the controller comprising:
an interface communicatively coupled to a variable speed compressor configured to operate at a plurality of speeds and compress a refrigerant used to cool air provided to the space;
a memory configured to store control logic comprising an integral gain and a control setpoint value; and
a processor communicatively coupled to the interface and the memory, the processor configured to:
determine that the HVAC system is requested to operate according to a demand response during a demand response time, wherein the demand response is a request to operate the HVAC system at a reduced power consumption, wherein the demand response is associated with an offset setpoint temperature that is greater than a baseline setpoint temperature used during normal operation of the HVAC system outside of the demand response time;
determine a curtailment compressor speed that achieves the reduced power consumption requested by the demand response;
at a start of the demand response time, begin operating the variable speed compressor at the curtailment speed; and
during the demand response time, adjust the speed of the variable speed compressor using the control logic with the offset setpoint temperature used as the control setpoint value when an indoor air temperature of the space is less than the offset setpoint temperature and greater than the baseline setpoint temperature.

16. The controller of claim 15, wherein the processor is further configured to determine the curtailment speed by:
determining an amount of energy consumed by the HVAC system as a function of a speed of the variable speed compressor; and
determining the curtailment speed as the speed of that variable speed compressor that corresponds to an energy consumption allowed during the demand response time.

17. The controller of claim 15, wherein the processor is further configured to:
determine that the indoor air temperature of the space is greater than the offset setpoint temperature; and
after determining that the indoor air temperature of the space is greater than the offset setpoint temperature, adjust the integral gain of the control logic of the controller, such that the speed of the variable speed compressor increases.

18. The controller of claim 17, wherein the processor is further configured to determine the amount based on a change in the value of the indoor air temperature over a previous interval of time.

19. The controller of claim 15, wherein the processor is further configured to:
determine that the indoor air temperature of the space is less than the baseline setpoint temperature; and
after determining that the indoor air temperature of the space is less than the baseline setpoint temperature, adjust the integral gain to zero or turn off the variable speed compressor.

20. The controller of claim 15, wherein the processor is further configured to:
determine that the demand response time is ended; and
after determining that the demand response time is ended, adjust the speed of the variable speed compressor using the control logic using the baseline setpoint temperature as the control setpoint value.
